(19) United States
(12) Patent Application Publication
(10) Pub. No.: US 2016/0198547 A1
(43) Pub. Date: Jul. 7, 2016

(54) INTELLIGENT LIGHT CONTROL SYSTEM AND LIGHT SWITCH APPARATUS WITH FUNCTION OF POWER METER

(71) Applicant: LUXUL TECHNOLOGY INCORPORATION, New Taipei City (TW)

(72) Inventors: Cheng-Hung PAN, New Taipei City (TW); Eric Wen-Chien Chen, New Taipei City (TW)

(21) Appl. No.: 14/715,530

(22) Filed: May 18, 2015

(30) Foreign Application Priority Data
Jan. 7, 2015 (TW) 104100404

(51) Int. Cl. H05B 37/02

(52) U.S. Cl. CPC H05B 37/0227; H05B 37/0272; H05B 37/0281

(57) ABSTRACT

An intelligent light control system has an electronic device and a light switch apparatus with a function of a power meter. The electronic device generates a remote control command or a read command based on a user's operation. The remote control command or the read command is transmitted to the light switch apparatus. The light switch apparatus turns on or turns off an illuminating apparatus according to the remote control command. The light switch apparatus sends power consumption to the electronic device according to the read command, such that the electronic device displays the power consumption. For convenience, the user can remotely turn on or turn off the illuminating apparatus by operating the electronic device, and can monitor and manage the use of the illuminating apparatus by reviewing the power consumption.

### CROSS-REFERENCE TO RELATED APPLICATIONS

This application claims the benefit of Taiwan patent application No. 104100404, filed on Jan. 7, 2015, the disclosure of which is incorporated herein in its entirety by reference.

### BACKGROUND OF THE INVENTION

1. Field of the Invention

The present invention relates to a light control system and a light switch apparatus, and more particularly to an intelligent light control system and a light switch apparatus with a function of an intelligent power meter.

2. Description of Related Art

A conventional light switch is used to turn on or turn off an illuminating apparatus. When a user wants to operate the light switch, the user has to get close to the light switch, and then press a button of the light switch by a finger to switch on or switch off the illuminating apparatus. When a distance between the user and the light switch is too long, the user has to move toward the light switch. However, a dimly-lit environment causes poor visibility. When the user is moving, the user may hit a wall or a desk and get hurt.

### SUMMARY OF THE INVENTION

An objective of the present invention is to provide an intelligent light control system and a light switch apparatus with a function of a power meter.

The light switch apparatus with a function of a power meter for controlling an illuminating apparatus comprises a sensing-and-computing module, a wireless transmitting module, a processing unit, a switch module, and a physical switch. The sensing-and-computing module is electrically connected to the illuminating apparatus to detect a working voltage and a working current of the illuminating apparatus, and calculates a power consumption of the illuminating apparatus. The wireless transmitting module wirelessly receives a remote control command or a read command. The processing unit is electrically connected to the sensing-and-computing module, the wireless transmitting module, and a memory unit. The processing unit receives the power consumption from the sensing-and-computing module and stores the power consumption in the memory unit. When the wireless transmitting module receives the remote control command, the processing unit generates an operating command according to the remote control command and sends out the operating command. When the wireless transmitting module receives the read command, the processing unit sends out the power consumption stored in the memory unit via the wireless transmitting module. The switch module is electrically connected to the illuminating apparatus and the processing unit. The switch module turns on or turns off the illuminating apparatus according to the operating command. The physical switch is connected to the switch module, and is operable to turn on or turn off the illuminating apparatus via the switch module.

Based on the light switch apparatus of the present invention, the user can operate the physical switch to turn on or turn off the illuminating apparatus. Besides, the user can also remotely turn on or turn off the illuminating apparatus by using the electronic device that transmits the remote control command to the light switch apparatus. Compared with the prior art that just provides the light switch, the present invention having the remote control function is more convenient. In addition, the light switch apparatus senses the working voltage and the working current of the illuminating apparatus, and further calculates and stores the power consumption. The user can monitor and manage the use of the illuminating apparatus based on the power consumption stored in the light switch apparatus.

The intelligent light control system for controlling an illuminating apparatus comprises a light switch apparatus and an electronic device. The light switch apparatus with a function of a power meter turns on or turns off the illuminating apparatus and comprises a sensing-and-computing module, a wireless transmitting module, a processing unit, a switch module, and a physical switch. The sensing-and-computing module is electrically connected to the illuminating apparatus to detect a working voltage and a working current of the illuminating apparatus, and calculates a power consumption of the illuminating apparatus. The wireless transmitting module wirelessly receives a remote control command or a read command. The processing unit is electrically connected to the sensing-and-computing module, the wireless transmitting module, and a memory unit. The processing unit receives the power consumption from the sensing-and-computing module and stores the power consumption in the memory unit. When the wireless transmitting module receives the remote control command, the processing unit generates an operating command according to the remote control command and sends out the operating command. When the wireless transmitting module receives the read command, the processing unit sends out the power consumption stored in the memory unit via the wireless transmitting module. The switch module is electrically connected to the illuminating apparatus and the processing unit. The switch module turns on or turns off the illuminating apparatus according to the operating command. The physical switch is connected to the switch module, and is operable to turn on or turn off the illuminating apparatus via the switch module. The electronic device comprises an input module, a processing module, a wireless transmitting module, and a display module. The input module generates an input signal. The processing module is electrically connected to the input module to receive the input signal, and generate the remote control command according to the input signal. The wireless transmitting module wirelessly communicates with the wireless transmitting module of the light switch apparatus and is electrically connected to the processing module. The wireless transmitting module receives the remote control command from the processing module, and sends the remote control command to the light switch apparatus. The display module is electrically connected to the processing module. The input module further generates the read command for the processing module. The processing module transmits the read command to the light switch apparatus via the wireless transmitting module to read the power consumption stored in the memory unit of the light switch apparatus. The display module displays the power consumption.

Another intelligent light control system comprises multiple light switch apparatuses and an electronic device. The multiple light switch apparatuses with a function of a power meter respectively turn on or turn off multiple illuminating apparatuses. Each light switch apparatus comprises a sensing-and-computing module, a wireless transmitting module, a processing unit, a switch module, and a physical switch. The sensing-and-computing module is electrically connected to the illuminating apparatus to detect a working voltage and a working current of the illuminating apparatus, and calculates a power consumption of the illuminating apparatus. The wireless transmitting module wirelessly receives a remote control command or a read command. The processing unit is electrically connected to the sensing-and-computing module, the wireless transmitting module, and a memory unit. The processing unit receives the power consumption from the sensing-and-computing module and stores the power consumption in the memory unit. When the wireless transmitting module receives the remote control command, the processing unit generates an operating command according to the remote control command and sends out the operating command. When the wireless transmitting module receives the read command, the processing unit sends out the power consumption stored in the memory unit via the wireless transmitting module. The switch module is electrically connected to the illuminating apparatus and the processing unit. The switch module turns on or turns off the illuminating apparatus according to the operating command. The physical switch is connected to the switch module, and is operable to turn on or turn off the illuminating apparatus. The electronic device comprises an input module, a processing module, a wireless transmitting module, and a display module. The input module generates an input signal. The processing module is electrically connected to the input module to receive the input signal, and generates the remote control command according to the input signal, wherein the remote control command corresponds to one of the light switch apparatuses. The wireless transmitting module wirelessly communicates with the wireless transmitting module of the light switch apparatus and is electrically connected to the processing module. The wireless transmitting module receives the remote control command from the processing module, and sends the remote control command to the light switch apparatus that corresponds to the remote control command. The display module is electrically connected to the processing module. The input module further generates the read command for the processing module, wherein the read command corresponds to one of the light switch apparatuses. The processing module transmits the read command via the wireless transmitting module to the light switch apparatus that corresponds to the read command to read the power consumption stored in the memory unit of the light switch apparatus, and the display module displaying the power consumption.

Based on the intelligent light control system of the present invention, the electronic device can remotely control one or multiple light switch apparatuses. Each light switch apparatus has the physical switch to directly turn on or turn off the illuminating apparatus. The sensing-and-computing module of the light switch apparatus senses the working voltage and the working current for calculating the power consumption of the illuminating apparatus. The power consumption is transmitted to the processing unit. The processing unit stores the power consumption in the memory unit. When the user wants to review the power consumption of one of the illuminating apparatuses, the user can operate the input module of the electronic device to select one of the illuminating apparatuses. Therefore, the electronic device communicates with a corresponding light switch apparatus according to the read command to read the power consumption. The electronic device then displays the power consumption. The user can review the power consumption to monitor and manage the use of the illuminating apparatus.

### BRIEF DESCRIPTION OF THE DRAWINGS

FIG. 1 is a block diagram of a first embodiment of an intelligent light control system of the present invention;

FIG. 2 is a block diagram of an embodiment of an electronic device of the present invention;

FIG. 3 is a schematic diagram of the first embodiment of an intelligent light control system of the present invention;

FIG. 4 is a schematic diagram of an electronic device of the present invention displaying the working voltage, the working current, the power consumption, the power, the power factor, and the electricity cost;

FIG. 5 is a schematic diagram of an electronic device of the present invention performing an auto-switch function;

FIG. 6 is a schematic diagram showing that a light switch apparatus, an electronic device, and a server communicate with the Internet;

FIG. 7 is a schematic diagram showing that an electronic device communicates with the Internet via the light switch apparatus and the wireless router; and

FIG. 8 is a schematic diagram showing that the light switch apparatuses communicate with each other and the Internet.

### DETAILED DESCRIPTION OF THE PREFERRED EMBODIMENT

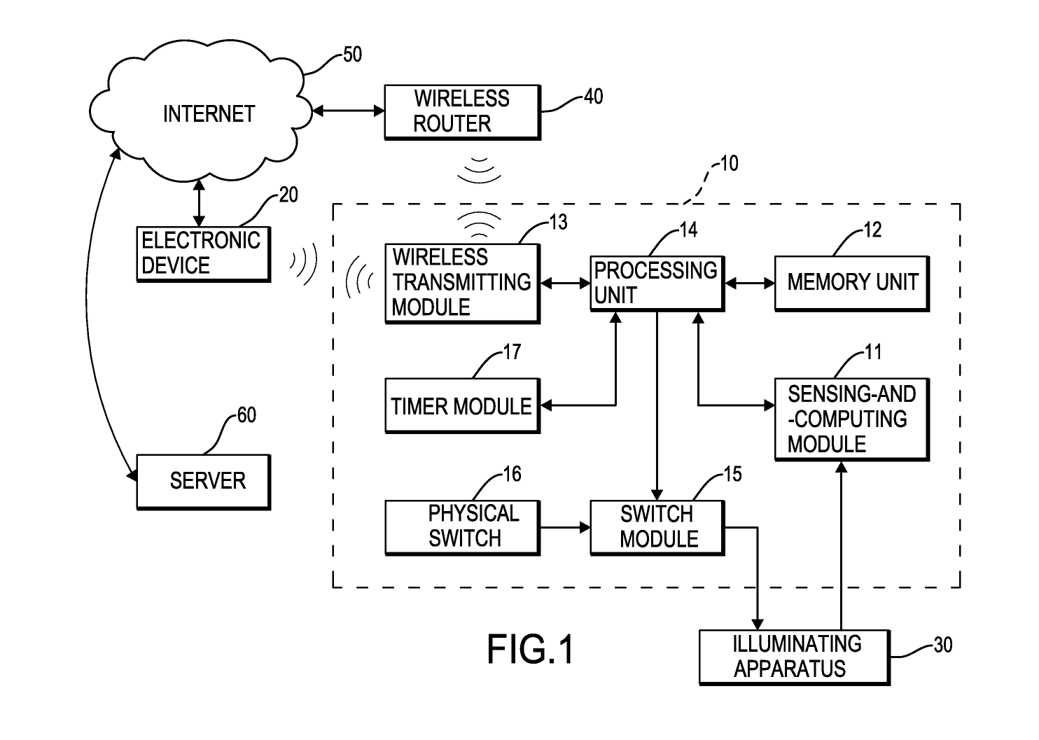

With reference to FIG. 1, a first embodiment of an intelligent light control system of the present invention is disclosed. The intelligent light control system comprises a light switch apparatus 10 and an electronic device 20. The light switch apparatus 10 is electrically connected to an illuminating apparatus 30 to turn on or turn off the illuminating apparatus 30. The light switch apparatus 10 has a function of a power meter.

The light switch apparatus 10 comprises a sensing-and-computing module 11, a memory unit 12, a wireless transmitting module 13, a processing unit 14, a switch module 15, and a physical switch 16. The processing unit 14 is electrically connected to the sensing-and-computing module 11, the memory unit 12, the wireless transmitting module 13, and the switch module 15.

The sensing-and-computing module 11 is electrically connected to the illuminating apparatus 30 to sense a working voltage and a working current of the illuminating apparatus 30. The sensing-and-computing module 11 calculates a power consumption of the illuminating apparatus 30 based on the working voltage and the working current. A calculated result, including the working voltage, the working current, and the power consumption, is transmitted to the processing unit 14 by the sensing-and-computing module 11. The processing unit 14 receives the calculated result from the sensing-and-computing module 11 and stores the calculated result in the memory unit 12.

The wireless transmitting module 13 may receive a remote control command or a read command. When the wireless transmitting module 13 receives the remote control command or the read command, the wireless transmitting module 13 transmits the remote control command or the read command to the processing unit 14. When the processing unit 14 receives the read command, the processing unit 14 reads the calculated result in the memory unit 12 and sends out the calculated result. When the processing unit 14 receives the remote control command, the processing unit 14 correspondingly generates an operating command, and then sends the operating command to the switch module 15. Upon receipt of the operating command, the switch module 15 turns on or turns off the illuminating apparatus 30. Besides, since the physical switch 16 is connected to the switch module 15, a user may alternatively operate the physical switch 16 to turn on or turn off the illuminating apparatus 30 via the switch module 15.

In this embodiment, communication of the wireless transmitting module 13 may be, but is not limited to, Wi-Fi communication. The physical switch 16 may be, but is not limited to, a button switch or a touch sensor switch.

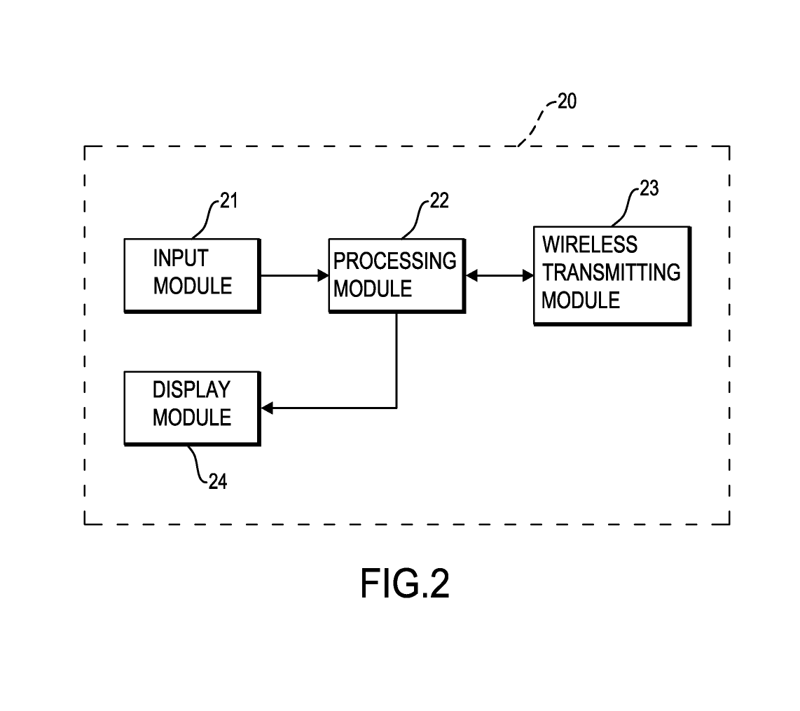

With reference to FIG. 2, the electronic device 20 comprises an input module 21, a processing module 22, a wireless transmitting module 23, and a display module 24. The processing module 22 is electrically connected to the input module 21, the wireless transmitting module 23, and the display module 24. The input module 21 is operable by a user to generate an input signal according to the user's operation. The processing module 22 receives the input signal from the input module 21, and correspondingly generates the remote control command as mentioned above. The wireless transmitting module 23 wirelessly communicates with the wireless transmitting module 13 of the light switch apparatus 10 for data transmission and command transmission. When the wireless transmitting module 23 receives the remote control command from the processing module 22, the wireless transmitting module 23 sends the remote control command to the wireless transmitting module 13 of the light switch apparatus 10.

The input module 21 generates the read command as mentioned above according to an access operation of the user, and sends the read command to the processing module 22. The processing module 22 transmits the read command to the light switch apparatus 10 via the wireless transmitting module 23, and then receives the calculated result from the light switch apparatus 10. Afterwards, the processing module 22 activates the display module 24 to display the power consumption of the calculated result of the illuminating apparatus 30.

In the intelligent light control system of the present invention, the user can directly operate the physical switch 16 to turn on or turn off the illuminating apparatus 30. Further, the user can operate the electronic device 20 to remotely turn on or turn off the illuminating apparatus 30, such that the user would not need to move close to the physical switch 16 to turn on or turn off the illuminating apparatus 30.

The intelligent light control system of the present invention has the function of an intelligent power meter. The light switch apparatus 10 has the sensing-and-computing module 11 to sense the working voltage and the working current of the illuminating apparatus 30, to calculate the power consumption of the illuminating apparatus 30 based on the working voltage and the working current, and then send the calculated result to the processing unit 14. The processing unit 14 stores the calculated result in the memory unit 12. When the user wants to know a working status of the illuminating apparatus 30, the user can operate the electronic device 20 to obtain the information of the power consumption of the illuminating apparatus 30 from the light switch apparatus 10. The power consumption is displayed on the display module 24. Hence, the user can review the power consumption of the illuminating apparatus 30 on the electronic device 20 to know the working status of the illuminating apparatus 30.

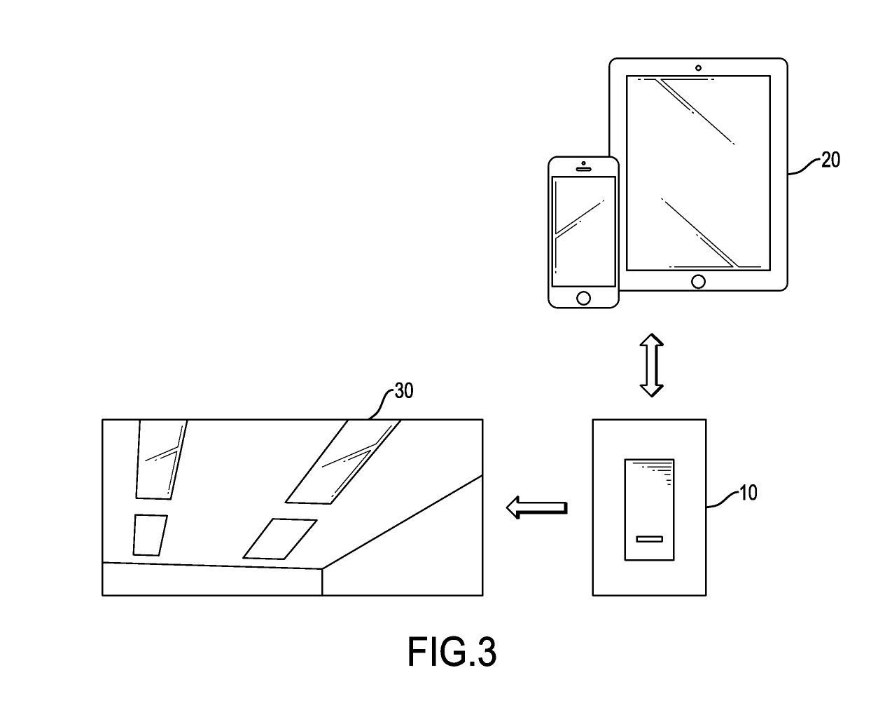

The electronic device 20 can be a smart phone, a tablet, a personal computer, a portable device, or a wearable device. The light switch apparatus 10 can be a common light switch or a touch pad. With reference to FIG. 3, for example, an application (APP) is installed on the smart phone or the tablet. The smart phone or the table executing the APP can remotely turn on or turn off the illuminating apparatus 30, and display the power consumption of the illuminating apparatus 30 for a user reviewing it. An objective to monitor and control the working status of the illuminating apparatus 30 is achieved.

In this embodiment, the illuminating apparatus 30 is composed of one or multiple light units. When the illuminating apparatus 30 is composed of a single light unit, the user can turn on or turn off the single light unit by operating the electronic device 20. When the illuminating apparatus 30 is composed of multiple light units, the user can synchronously turn on or turn off the light units by operating the electronic device 20. For example, the illuminating apparatus can be composed of multiple fluorescent lamps mounted in an office space. The user can operate the electronic device 20 to turn on or turn off any one of the fluorescent lamps individually or all of the fluorescent lamps synchronously.

In addition, the sensing-and-computing module 11 of the electronic device 10 further calculates a power and a power factor of the illuminating apparatus 30. The calculated result, including the working voltage, the working current, the power consumption, the power, and the power factor of the illuminating apparatus 30, is transmitted to the processing unit 14 by the sensing-and-computing module 11. The processing unit 14 then stores the calculated result in the memory unit 12.

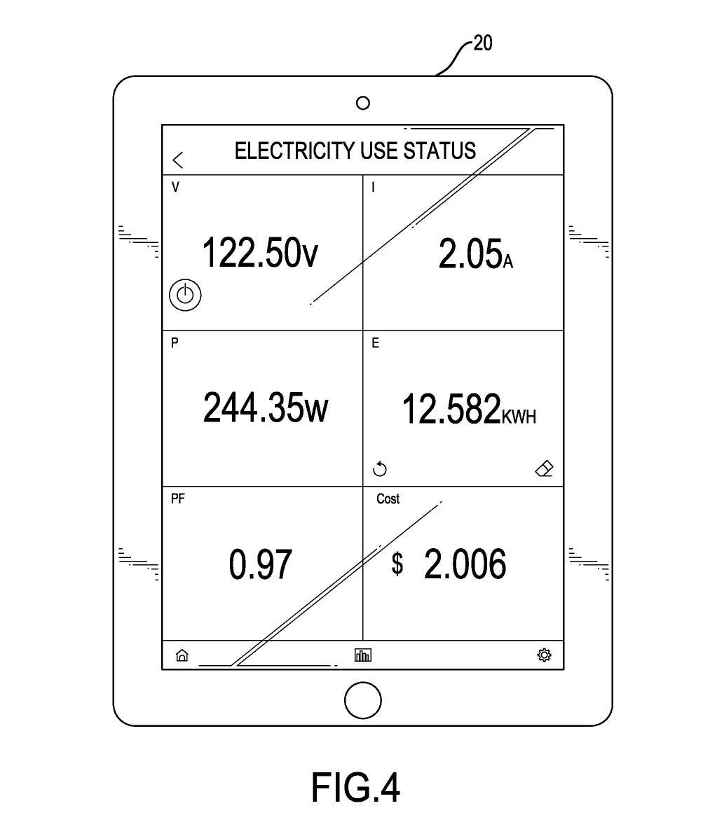

With reference to FIG. 4, the processing module 22 of the electronic device 20 can read and display the calculated result including the working voltage, the working current, the power consumption, the power, and the power factor of the illuminating apparatus 30 from the memory unit 12 of the light switch apparatus 10. Besides, the processing module 22 can receive and display the calculated result from the sensing-and-computing module 11 of the light switch apparatus 10 in real-time. The processing module 22 calculates electricity cost of the illuminating apparatus 30 according to the power consumption. The electronic device 20 also display the working voltage (V), the working current (I), the power (P), the power factor (PF), the power consumption (E), and the electricity cost (Cost) on the display module 24. Unit of the power consumption can be Kilo-Watt per hour (KWH).

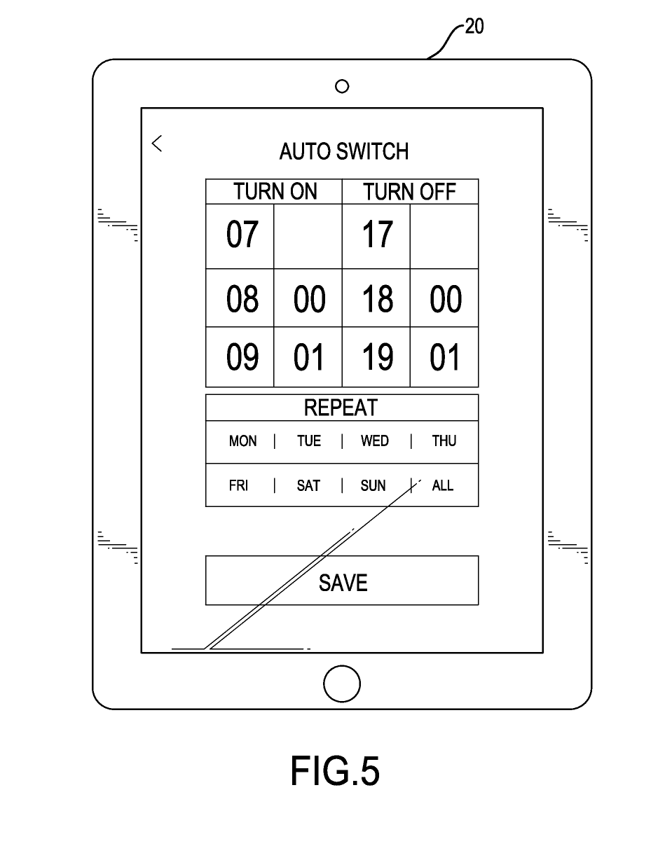

With reference to FIG. 1 and FIG. 5, the intelligent light control system of the present invention has an auto-switch function. The light switch apparatus 10 further has a timer module 17 electrically connected to the processing unit 14. The electronic device 20 can perform the auto-switch function by the user's operation. The user inputs a turn-on timing and a turn-off timing to the input module 21. The turn-on timing and the turn-off timing are transmitted to the light switch apparatus 10 via the processing module 22 and the wireless transmitting module 23. When the light switch apparatus 10 receives the turn-on timing and the turn-off timing, the processing unit 14 of the light switch apparatus 10 sets the turn-on timing and the turn-off timing to the timer module 17. Afterwards, when a present time matches the turn-on timing, the processing unit 14 controls the switch module 15 to turn on the illuminating apparatus 30. When the present time matches the turn-off timing, the processing unit 14 controls the switch module 15 to turn off the illuminating apparatus 30. An objective of auto-switch is achieved.

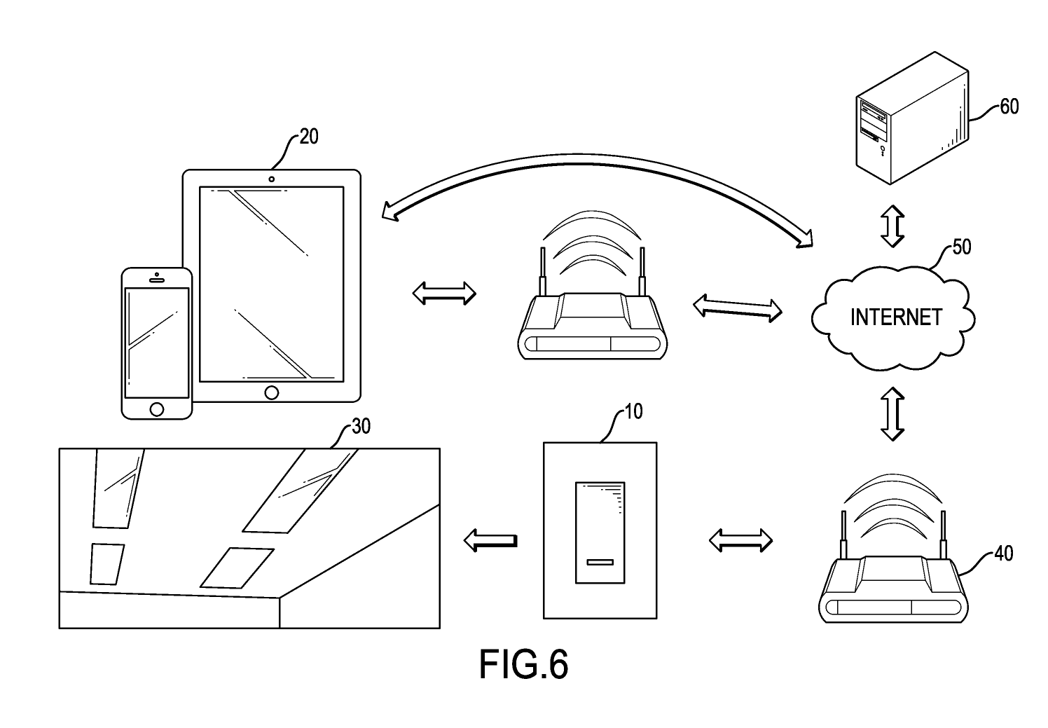

With reference to FIG. 6, the intelligent light control system of the present invention further comprises a wireless router 40. The wireless transmitting module 13 of the light switch apparatus 10 wirelessly communicates with the wireless transmitting module 23 of the electronic device 20 and the wireless router 40, such that the light switch apparatus 10 can be connected to the Internet 50 via the wireless router 40. When a distance between the electronic device 20 and the light switch apparatus 10 is longer than a maximum distance for wireless connection, the electronic device 20 and the light switch apparatus 10 fail to directly communicate with each other. However, the electronic device 20 accessing the Internet 50 is still connected to the light switch apparatus 10 accessing the Internet 50 via the wireless router 40. Hence, the electronic device 20 and the light switch apparatus 10 indirectly communicate with each other. The electronic device 20 can transmit commands to the light switch apparatus 10 and receive the calculated result from the light switch apparatus 10 through the Internet 50. The electronic device 20 can communicate with the Internet 50 via mobile communication, or the electronic device 20 can communicate with a near wireless router which communicates with the Internet 50. In other words, when the electronic device 20 is capable of communicating with the Internet 50, the user can operate the electronic device 20 to wirelessly control the light switch apparatus 10 to turn on or turn off the illuminating apparatus 30.

The calculated result stored in the memory unit 12 of the light switch apparatus 10, including the working voltage, the working current, the power consumption, the power, the power factor, and the electricity cost, is accessible and can be transmitted to a server 60 via the wireless transmitting module 13, the wireless router 40, and the Internet 50. Or, the processing unit 14 of the light switch apparatus 10 can directly transmit the calculated result to the server 60 via the wireless transmitting module 13, the wireless router 40, and the Internet 50. An administrator who communicates with the server 60 via the Internet 50 can review the calculated result of the illuminating apparatus 30 stored in the server 60 to monitor and manage the illuminating apparatus 30.

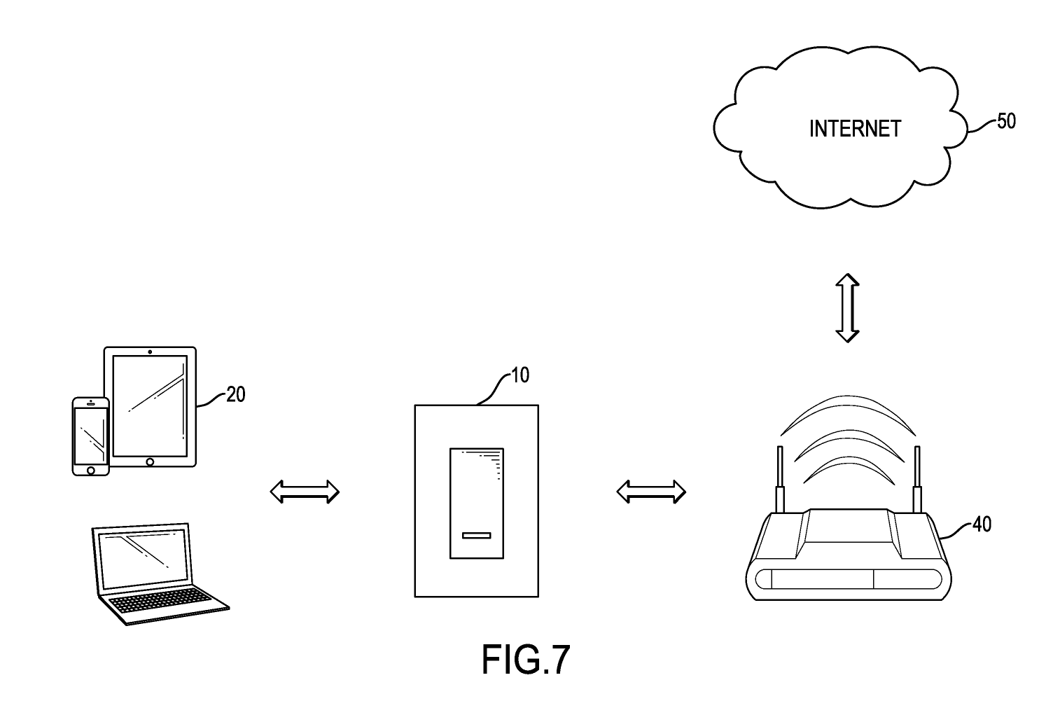

With reference to FIG. 7, the light switch apparatus 10 communicates with the Internet 50 via the wireless router 40. The electronic device 20 communicates with the light switch apparatus 10. The light switch apparatus 10 is as a wireless intermediate station to expand the wireless connection range for the electronic device 20. The electronic device 20 communicates with the Internet 50 via the light switch apparatus 10 and the wireless router 40. Hence, although the electronic device 20 fails to directly communicate with the Internet 50 via the mobile communication, and the electronic device 20 fails to communicate with the wireless router 40 because the distance between the electronic device 20 and the wireless router 40 is too long, the electronic device 20 can still access the Internet 50.

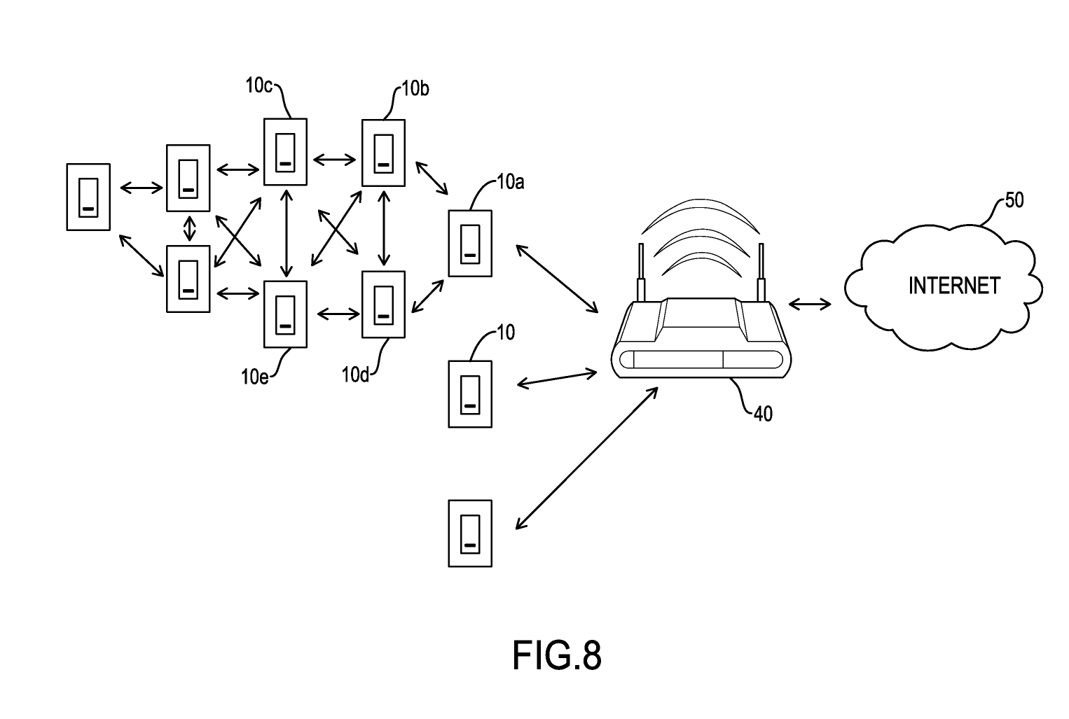

With reference to FIG. 8, a second embodiment of the intelligent light control system has an electronic device 20 and multiple light switch apparatuses 10 with a function of a power meter. The multiple light switch apparatuses 10 are respectively used to turn on or turn off multiple illuminating apparatuses 30. The remote control command generated by the electronic device 20 corresponds to one of the light switch apparatuses 10. The read command generated by the electronic device 20 corresponds to one of the light switch apparatuses 10. The wireless transmitting module 23 of the electronic device 20 communicates with one of the light switch apparatuses 10 according to the remote control command. The wireless transmitting module 23 of the electronic device 20 communicates with one of the light switch apparatuses 10 according to the read command, such that the electronic device 20 can read the power consumption of a corresponding illuminating apparatus 30 from the memory unit 12 of the light switch apparatus 10, and display the power consumption on the display module 24.

The multiple light switch apparatuses 10 can directly communicate with the electronic device 20, or the multiple light switch apparatuses 10 can communicate with the electronic device 20 via the Internet 50. In addition, the multiple light switch apparatuses 10 can communicate with each other. Any one of the light switch apparatuses 10 can communicate with the electronic device 20 via another light switch apparatus 10. For example, with reference to FIG. 8, the intelligent light control system comprises a first light switch apparatus 10a, a second light switch apparatus 10b, a third light switch apparatus 10c, a fourth light switch apparatus 10d, and a fifth light switch apparatus 10e. The light switch apparatuses 10a-10e communicate with each other. The first light switch apparatus 10a is connected to the Internet 50 via the wireless router 40. The user can connect the electronic device 20 to the Internet 50 anytime and anywhere, and turn on or turn off the first light switch apparatus 10a, and further turn on or turn off any one of the second to fifth light switch apparatuses 10b-10e via the first light switch apparatus 10a.

When the sensing-and-computing module 11 of the light switch apparatus 10 generates the calculated result including the working voltage, the working current, the power, the power factor, the power consumption, and the electricity cost of the illuminating apparatus 30, the processing unit 14 periodically stores the calculated result in the memory unit 12, or directly sends the calculated result to the server 60 via the wireless transmitting module 13, the wireless router 40, and the Internet 50. For example, the time interval for the processing unit 14 to store the calculated result is an hour. The server 60 can store the calculated result of the illuminating apparatus 30 per hour. The administrator can review the use of the illuminating apparatus 30 for each hour of a day. During non-office hours of an office space, the calculated result of the illuminating apparatus 30 reflects the use of the illuminating apparatus 30 for confirming whether any staff is still in the office.

When the server 60 communicates with the multiple light switch apparatuses 10, the server 60 can determine priority to each light switch apparatus 10. The priority of each light switch apparatus 10 is a reference for a power company to manage electricity rationing. For example, an area in divided into multiple individual parts. The server 60 can be a client server of a power company. The power company transmits electricity to the parts respectively. During electricity rationing, in the past, the electricity supply for all of the parts is cut off by the power company, causing inconvenience in use for the users. In the present invention, the server 60 sets the priority to each of the light switch apparatuses 10. The power company thus sequentially cuts off supply of the electricity of the parts of the area according to the priority of the light switch apparatuses 10.

For example, for preliminary and low-scale electricity rationing, the server 60 controls the light switch apparatuses 10 with the lowest priority to turn off the corresponding illuminating apparatuses 30. When the requirement for electricity rationing increases, the server 60 controls the light switch apparatuses 10 with the lowest and the second lowest priority to turn off the corresponding illuminating apparatuses 30. Hence, the power company can set the priority to the light switch apparatuses 10 based on demands of the users. The power company would not cut off the electricity in all parts of the area. The impact from the electricity rationing is reduced.

What is claimed is:

1. A light switch apparatus with a function of a power meter for controlling an illuminating apparatus, the light switch apparatus comprising:
a sensing-and-computing module electrically connected to the illuminating apparatus to detect a working voltage and a working current of the illuminating apparatus, and calculating a power consumption of the illuminating apparatus;
a wireless transmitting module for wirelessly receiving a remote control command or a read command;
a processing unit electrically connected to the sensing-and-computing module, the wireless transmitting module, and a memory unit, the processing unit receiving the power consumption from the sensing-and-computing module and storing the power consumption in the memory unit; when the wireless transmitting module receives the remote control command, the processing unit generating an operating command according to the remote control command and sending out the operating command; when the wireless transmitting module receives the read command, the processing unit sending out the power consumption stored in the memory unit via the wireless transmitting module;
a switch module electrically connected to the illuminating apparatus and the processing unit, the switch module turning on or turning off the illuminating apparatus according to the operating command; and
a physical switch connected to the switch module, the physical switch being operable to turn on or turn off the illuminating apparatus via the switch module.

2. The light switch apparatus as claimed in claim 1, wherein
the sensing-and-computing module calculates a power and a power factor of the illuminating apparatus, and sends the working voltage, the working current, the power, and the power factor of the illuminating apparatus to the processing unit;
the processing unit stores the working voltage, the working current, the power, and the power factor of the illuminating apparatus in the memory unit.

3. The light switch apparatus as claimed in claim 1, wherein the light switch apparatus has a timer module electrically connected to the processing unit;
the wireless transmitting module receives a turn-on timing and a turn-off timing from an electronic device;
the processing unit sets the turn-on timing and the turn-off timing to the timer module; and
when a present time matches the turn-on timing, the processing unit controls the switch module to turn on the illuminating apparatus; when the present time matches the turn-off timing, the processing unit controls the switch module to turn off the illuminating apparatus.

4. The light switch apparatus as claimed in claim 2, wherein
the light switch apparatus has a timer module electrically connected to the processing unit;
the wireless transmitting module receives a turn-on timing and a turn-off timing from an electronic device;
the processing unit sets the turn-on timing and the turn-off timing to the timer module; and
when a present time matches the turn-on timing, the processing unit controls the switch module to turn on the illuminating apparatus; when the present time matches the turn-off timing, the processing unit controls the switch module to turn off the illuminating apparatus.

5. An intelligent light control system for controlling an illuminating apparatus, the intelligent light control system comprising:
a light switch apparatus with a function of a power meter, the light switch apparatus for turning on or turning off the illuminating apparatus and comprising:
a sensing-and-computing module electrically connected to the illuminating apparatus to detect a working voltage and a working current of the illuminating apparatus, and calculating a power consumption of the illuminating apparatus;
a wireless transmitting module wirelessly receiving a remote control command or a read command;
a processing unit electrically connected to the sensing-and-computing module, the wireless transmitting module, and a memory unit, the processing unit receiving the power consumption from the sensing-and-computing module and storing the power consumption in the memory unit; when the wireless transmitting module receives the remote control command, the processing unit generating an operating command according to the remote control command and sending out the operating command; when the wireless transmitting module receives the read command, the processing unit sending out the power consumption stored in the memory unit via the wireless transmitting module;
a switch module electrically connected to the illuminating apparatus and the processing unit, the switch module turning on or turning off the illuminating apparatus according to the operating command; and
a physical switch connected to the switch module, the physical switch being operable to turn on or turn off the illuminating apparatus via the switch module; and
an electronic device comprising:
an input module generating an input signal;
a processing module electrically connected to the input module to receive the input signal, and generating the remote control command according to the input signal;
a wireless transmitting module wirelessly communicating with the wireless transmitting module of the light switch apparatus and electrically connected to the processing module, the wireless transmitting module of the electronic device receiving the remote control command from the processing module, and sending the remote control command to the light switch apparatus;
a display module electrically connected to the processing module;
the input module further generating the read command for the processing module, the processing module transmitting the read command to the light switch apparatus via the wireless transmitting module of the electronic device to read the power consumption stored in the memory unit of the light switch apparatus, and the display module displaying the power consumption.

6. The intelligent light control system as claimed in claim 5, wherein
the sensing-and-computing module of the light switch apparatus calculates a power and a power factor of the illuminating apparatus, and the processing unit stores the working voltage, the working current, the power, and the power factor in the memory unit;
the processing module transmits the read command to the light switch apparatus to read the working voltage, the working current, the power, and the power factor stored in the memory unit of the light switch apparatus, and the display module displays the working voltage, the working current, the power, and the power factor.

7. The intelligent light control system as claimed in claim 5, wherein
the processing module of the electronic device calculates electricity cost according to the power consumption; and
the display module of the electronic device displays the electricity cost.

8. The intelligent light control system as claimed in claim 6, wherein
the processing module of the electronic device calculates electricity cost according to the power consumption; and
the display module of the electronic device displays the electricity cost.

9. The intelligent light control system as claimed in claim 5, wherein
a turn-on timing and a turn-off timing are transmitted to the light switch apparatus via the processing module and the wireless transmitting module of the electronic device;
the light switch apparatus comprises a timer module electrically connected to the processing unit;
when the light switch apparatus receives the turn-on timing and the turn-off timing, the processing unit of the light switch apparatus sets the turn-on timing and the turn-off timing to the timer module;
when a present time matches the turn-on timing, the processing unit controls the switch module to turn on the illuminating apparatus; and
when the present time matches the turn-off timing, the processing unit controls the switch module to turn off the illuminating apparatus.

10. The intelligent light control system as claimed in claim 6, wherein
a turn-on timing and a turn-off timing are transmitted to the light switch apparatus via the processing module and the wireless transmitting module of the electronic device;
the light switch apparatus comprises a timer module electrically connected to the processing unit;
when the light switch apparatus receives the turn-on timing and the turn-off timing, the processing unit of the light switch apparatus sets the turn-on timing and the turn-off timing to the timer module;
when a present time matches the turn-on timing, the processing unit controls the switch module to turn on the illuminating apparatus; and
when the present time matches the turn-off timing, the processing unit controls the switch module to turn off the illuminating apparatus.

11. The intelligent light control system as claimed in claim 5, wherein
the intelligent light control system comprises a wireless router communicating with the Internet;
the wireless transmitting module of the light switch apparatus communicates with the wireless router to be connected to the Internet via the wireless router; and
the wireless transmitting module of the electronic device communicates with the Internet to be connected to the light switch apparatus via the wireless router.

12. The intelligent light control system as claimed in claim 6, wherein
the intelligent light control system comprises a wireless router communicating with the Internet;
the wireless transmitting module of the light switch apparatus communicates with the wireless router to be connected to the Internet via the wireless router; and
the wireless transmitting module of the electronic device communicates with the Internet to be connected to the light switch apparatus via the wireless router.

13. The intelligent light control system as claimed in claim 11, wherein
the electronic device communicates with the wireless transmitting module of the light switch apparatus; and
the electronic device communicates with the Internet via the light switch apparatus and the wireless router.

14. The intelligent light control system as claimed in claim 12, wherein
the electronic device communicates with the wireless transmitting module of the light switch apparatus; and
the electronic device communicates with the Internet via the light switch apparatus and the wireless router.

15. An intelligent light control system for controlling multiple illuminating apparatuses, the intelligent light control system comprising:
multiple light switch apparatuses with a function of a power meter, the multiple light switch apparatuses for respectively turning on or turning off the multiple illuminating apparatuses, each light switch apparatus comprising:
a sensing-and-computing module electrically connected to the illuminating apparatus to detect a working voltage and a working current of the illuminating apparatus, and calculating a power consumption of the illuminating apparatus;
a wireless transmitting module wirelessly receiving a remote control command or a read command;
a processing unit electrically connected to the sensing-and-computing module, the wireless transmitting module, and a memory unit, the processing unit receiving the power consumption from the sensing-and-computing module and storing the power consumption in the memory unit; when the wireless transmitting module receives the remote control command, the processing unit generating an operating command according to the remote control command and sending out the operating command; when the wireless transmitting module receives the read command, the processing unit sending out the power consumption stored in the memory unit via the wireless transmitting module;
a switch module electrically connected to the illuminating apparatus and the processing unit, the switch module turning on or turning off the illuminating apparatus according to the operating command; and
a physical switch connected to the switch module, and being operable to turn on or turn off the illuminating apparatus; and
an electronic device comprising:
an input module generating an input signal;
a processing module electrically connected to the input module to receive the input signal, and generating the remote control command according to the input signal, wherein the remote control command corresponds to one of the light switch apparatuses;
a wireless transmitting module wirelessly communicating with the wireless transmitting module of the light switch apparatus and electrically connected to the processing module, the wireless transmitting module receiving the remote control command from the processing module, and sending the remote control command to the light switch apparatus that corresponds to the remote control command;
a display module electrically connected to the processing module;
the input module further generating the read command for the processing module, wherein the read command corresponds to one of the light switch apparatuses;
the processing module transmitting the read command via the wireless transmitting module to the light switch apparatus that corresponds to the read command to read the power consumption stored in the memory unit of the light switch apparatus, and the display module displaying the power consumption.

16. The intelligent light control system as claimed in claim 15, wherein
the multiple light switch apparatuses communicate with each other.
